(19) United States
(12) Patent Application Publication
(10) Pub. No.: US 2026/0008124 A1
(43) Pub. Date: Jan. 8, 2026

(54) MACHINE TOOL AND FLOW GUIDE DEVICE

(71) Applicant: DMG MORI ADDITIVE GmbH, Bielefeld (DE)

(72) Inventor: Stefan SCHOEN, Bielefeld (DE)

(21) Appl. No.: 18/993,904

(22) PCT Filed: Dec. 6, 2023
(86) PCT No.: PCT/EP2023/084485

§ 371 Date: Jan. 13, 2025

(30) Foreign Application Priority Data
Jan. 31, 2023 (DE) 10 2023 102 319.5

(51) Int. Cl. B23K 26/16

(52) U.S. Cl. CPC B23K 26/16

(57) ABSTRACT

The invention provides a machine tool 100 for the additive layered construction of workpieces, which comprises a processing chamber 10, in which the additive build-up of workpieces takes place, a process gas device 40, which is set up to introduce a process gas stream 41 into the processing chamber 10 during the additive build-up, and a flow guide element 51 for the process gas stream 41, which is fastened within the processing chamber 10 and which is elastically deformable between a first position, in which the flow guide element 51 has a first outer contour geometry, and a second position, in which the flow guide element 51 has a second outer contour geometry differing from the first.

### TECHNICAL FIELD

The present invention relates to a machine tool for the additive layered construction of workpieces and to a flow guide device for use in a machine tool.

### BACKGROUND OF THE INVENTION

From the state of the art, primary forming methods for the additive manufacture of three-dimensional workpieces are known, in the course of which a workpiece is built up in layers from a provided material.

For this purpose, a powder material is usually applied as a material layer to a carrier located in a processing chamber of a machine tool and then solidified by location-specific irradiation to form a workpiece layer, for example by way of a melting or a sintering of the individual material particles of the material layer.

If a workpiece layer is solidified, a new material layer of unprocessed material is applied to the carrier or to the already produced workpiece layer and a new location-specific irradiation takes place.

In this way, the workpiece is successively built up layer by layer from material of a plurality of material layers applied to the carrier.

In the course of this manufacturing process, undesirable effects usually occur, which have a negative effect on the process conditions within the processing chamber and thus ultimately also have a negative influence on the manufacturing quality.

Thus, the processing space delimited by the processing chamber is on the one hand loaded with contaminants, for example by exhaust gases arising during the solidification or by swirling of the unsolidified material. On the other hand, the process space is successively heated by the waste heat arising during the irradiation, which can lead for example to thermally caused deformations of individual components within the processing chamber.

In order to counteract these negative effects and to provide largely unchanged and optimum process conditions during the manufacturing process, a process gas stream is usually guided through the processing chamber, via which for example the said contaminants or the arising waste heat are discharged from the processing chamber.

However, in this case, the process gas stream itself can be a source of undesirable effects, such that it swirls for example the unsolidified material on the carrier, which not only contaminates the processing space itself, but also leads to an inhomogeneity in the applied material.

In order to counteract this, process gas stream and processing chamber are synchronized with one another, in order thus to provide for example as laminar a process gas stream as possible without swirling. This synchronization is made more difficult in particular by other components of the machine tool located in the processing chamber, such as for example a movable coater for applying the material to the carrier, at which undesirable swirling can occur.

From EP 3 928 900 A1, for this purpose, a machine tool with movable coater is known, in which a processing chamber is of substantially cuboid design, wherein planar side walls run parallel to an introduction direction of a process gas stream introduced into the processing chamber, so that the process gas stream can flow substantially along the planar elements, without swirling in the process. In order to eliminate the coater movable within the processing chamber as a source of undesirable swirling, it is moved out of the processing chamber via an opening in a side wall closable by a flap after material has been applied to the base-side carrier.

Such a solution requires a design of the entire processing chamber designed for the process gas stream with substantially purely planar boundary surfaces for guiding the process gas stream. As a result, on the one hand, the design freedom of the developers is considerably restricted and on the other hand, further components can almost not be retrofitted at all within the processing chamber, since these would cause a disturbance of the process gas stream. An optical system for monitoring the manufacturing process, lighting elements or other sensors/actuators for monitoring and controlling the manufacturing process may be mentioned as examples of such components.

### SUMMARY OF THE INVENTION

It is therefore an object of the present invention to provide an efficient possibility for the targeted guidance of a process gas stream through a processing chamber of a machine tool set up for additive manufacture, which is easily adaptable to variable configurations of the machine tool.

To achieve this object, a machine tool according to claim 1 and a flow guide device according to claim 20 are provided.

The respective dependent claims relate to preferred embodiments, which can each be provided alone or in combination.

According to a first aspect of the invention, a machine tool for the additive layered build-up of workpieces is provided, comprising a processing chamber, in which the additive manufacturing of workpieces takes place, a process gas device, which is set up to introduce a process gas stream into the processing chamber during the additive manufacturing, and a flow guide element for the process gas stream, which is fastened within the processing chamber and which is elastically deformable between a first position, in which the flow guide element has a first outer contour geometry, and a second position, in which the flow guide element has a second outer contour geometry differing from the first.

The flow guide element serves here to guide the process gas stream introduced at an inlet in a targeted manner through the processing chamber up to an outlet, as far as possible in the form of a laminar flow without swirling of the process gas stream or the like.

One or more sections of an outer contour of the flow guide element form for this purpose, at least in the first position of the flow guide element, one or more flow boundary surfaces of the process gas stream flowing through the processing chamber, which is guided starting from an inlet into the processing chamber along the flow boundary surface up to the outlet. The outer contour geometry here denotes the geometry of said outer contour.

Other flow boundary surfaces can be formed here by side/ceiling or base elements of the processing chamber.

The flow guide element fastened within the processing chamber thus establishes a flow boundary surface for the process gas stream which differs from the inner contour of the processing chamber, as a result of which said process gas stream can be guided in a targeted manner through a partial region of the process space delimited by the processing chamber (inner space of the processing chamber).

As a result, geometries, elements or components of the machine tool in the processing region leading to disturbances of the process gas stream can otherwise be shielded from the process gas stream via the flow guide element.

The elastic deformability according to the invention of the flow guide element, the outer contour of which can thereby be transferred between the first outer contour geometry and the second outer contour geometry, allows here an adaptation of the flow guide element to changing boundary conditions in the processing region, so that the process gas stream can always be guided optimally through the processing chamber. Traversing (i.e. moving) components of the machine tool in the course of the manufacturing process may be mentioned as an example of said changing boundary conditions.

The order of magnitude of the deformation between the first and the second position is noticeable here in such a way that it can be greater than 2%, preferably greater than 5% and even more preferably greater than 20%, for example in relation to a length or a width of the section of the flow guide element functioning as a flow boundary surface.

In a preferred embodiment, the flow guide element is designed in such a way that the first outer contour geometry substantially corresponds to a planar surface.

In this way, a geometry which is kept particularly simple for guiding the process gas stream and which does not lead to any swirling in comparison with an arbitrarily curved surface is provided.

In a preferred embodiment, the flow guide element is arranged in the first position in such a way that the planar surface runs parallel to an introduction direction of the introduced process gas stream.

Parallel is to be understood here as meaning that a direction vector of the introduction direction runs orthogonally to a normal vector of the planar surface.

In this way, the flow guide element is subjected to thrust (caused by thrust stresses in the fluid, that is to say in the process gas stream) only by the process gas stream flowing in in parallel, which, in contrast to a process gas stream which otherwise impinges at an angle and comes from the inlet, means a lower loading for the flow guide element.

Alternatively, however, the flow guide element can also be designed in such a way that the planar surface is at an angle to the introduction direction. In this case, the flow guide element can even be used as a deflection element in order to correct a direction of the introduced process gas stream, for example in order to compensate for assembly-related inaccuracies, in particular of the inlet.

Thus, the first position should not be restricted to the parallel arrangement, but can also be arranged at an angle to the introduction direction in such a way that the normal vector and the direction vector of the introduction direction are at an angle of 30 degrees to less than 90 degrees, preferably of 45 degrees to less than 90 degrees and particularly preferably of 70 degrees to less than 90 degrees, to one another.

Said angle is preferably adjustable via an adjustable bearing device, via which the flow guide element is fastened in the processing chamber.

In particular, the bearing device is attached to a ceiling element of the processing chamber and comprises a mounting element for mounting on the ceiling element and a holding element which is connected thereto and is adjustable at an angle in relation to the mounting element and to which the flow guide element is fastened.

Guide devices can preferably be provided on side elements of the processing chamber, in which one or more end sections of the flow guide element are guided, in particular in such a way that they are guided in a translationally displaceable manner in a displacement direction.

As a result, an additional support of the flow guide element is provided, with the result that there is a more stable fastening within the processing chamber, which additionally does not impede or block an optionally providable movement possibility of the flow guide element.

In a preferred embodiment, the flow guide element is a flexible surface element.

Surface element denotes an element whose geometric dimensions in a thickness direction (thickness) are preferably smaller than the dimensions in a width and a longitudinal direction (width and length).

It is preferably a thin surface element, in which a ratio of thickness to width or thickness to length is less than or equal to 10%, preferably less than 5%, more preferably less than 1% and particularly preferably less than 0.1%.

Flexible is to be understood here as meaning that the bending stiffness for bending deformations of the surface element in the thickness direction is smaller than a tensile stiffness in the longitudinal or width direction.

For the purpose of comparability of bending and tensile stiffnesses with regard to the different SI units, the bending stiffness can be understood as meaning the stiffness of the surface element, which describes the restoring force which counteracts an individual force acting on a reference point of the surface element in the thickness direction. The reference point is preferably placed here in a central region and not in an edge region of the surface element, in order thus to obtain a suitable reference value for the bending stiffness.

A ratio of the bending stiffness and the tensile stiffness in the longitudinal or width direction of the surface element is preferably less than 25%, preferably less than 10%, more preferably less than 5% and particularly preferably less than 1%.

As a result of the embodiment as a flexible surface element, the flow guide element can be deformed in a bending manner particularly simply and without great expenditure of force, which is beneficial in particular for the deformation from the first into the second position (or vice versa). On the other hand, the stiffnesses parallel to the surface functioning as a flow boundary surface are very great, and therefore shear distortions on account of the process gas stream are very small.

Accordingly, the flow guide element is preferably deformable by bending deformation between the first and the second position.

In a preferred embodiment, the flexible surface element is a film element or a woven element.

In this way, the flow guide element can be manufactured particularly cost-effectively.

The film element can be a metallic film or a plastic film. The woven element can consist of a woven or a knitted woven, for example of textile, plastic, carbon or metal fibers.

The sheet metal element can be a thin sheet metal, for example of an aluminum or steel alloy, in particular a spring steel strip. In this way, a particularly resistant flow guide element can be provided.

In a preferred embodiment, the flow guide element divides an inner space of the processing chamber into a first region and into a second region in the first position, wherein the first region is a processing region, in which the additive manufacturing takes place, and wherein the process gas device is set up to introduce the process gas stream into the first region.

In this way, a division of the processing chamber can be carried out particularly simply, in the course of which the processing region can be adapted geometrically optimally to the process gas stream independently of the size of the processing chamber. Furthermore, in this way, a region which is separated from the processing region is provided, in which region components of the machine tool can be arranged, which otherwise, that is to say in the case without division, would have a negative influence on the process gas stream. This can include, for example, additional sensor devices or a filling device for the material to be applied in layers, etc.

If the flow guide element is designed as a film element, it is preferably transparent (or semitransparent), and therefore an optical beam path can penetrate through it (for the most part) unhindered. As a result, for example, a machine operator can see the first region (processing region) through the flow guide element, in order to track manufacturing there.

In a preferred embodiment, a building field of the machine tool, on which the layered construction takes place, is arranged completely in the first region.

As a result, almost all sources of contaminants (swirled material, exhaust gases, combustion products) are arranged in the region through which the process gas stream flows, in which region these can be reliably discharged by the process gas stream. Furthermore, components of the machine tool arranged in the other region are shielded from said contaminants.

In a preferred embodiment, the processing chamber comprises lateral housing elements, a top-side housing element and a bottom-side housing element, wherein the housing elements and the flow guide element are arranged with respect to one another in such a way that, in the first position of the flow guide element, the introduced process gas stream flows as a parallel flow along the flow guide element through the first region of the inner space of the processing chamber.

As a result, sources of possible swirling in the first region of the inner space are reduced to a minimum, as a result of which a particularly stable flow state is achieved. In this way, swirling or swirling, if they occur, decay again comparatively quickly.

In a preferred embodiment, the machine tool comprises a coating device which is movable relative to the processing chamber between a first and a second end position, is set up to apply material layers for the additive manufacturing to a building field of the machine tool in the processing chamber, and is furthermore set up to elastically deform the flow guide element between the first position and the second position by a movement.

The coating device usually provided for applying material layers can thus be used as a component of the machine tool which is movable relative to the building field in the processing chamber, without the latter representing an element which disturbs the process gas stream in its end positions. The flow guide element here functions as a variable or passively adjustable separating element in the processing chamber, wherein an adjustment movement in this case is caused by the coating device. The coating device can thus move through the first region of the processing chamber without the need to provide complex separating elements with their own drive, in order to allow the latter access to or exit from the first region.

The coating device can thus displace the flow guide element in a reversible manner in the course of its movement, in order thus to achieve, for example, an end position lying outside the first region, without the flow guide element itself having to be moved via a drive or the like.

In a preferred embodiment, the flow guide element is brought into the second position when the coating device is situated in its first end position, wherein the flow guide element here bears at least partially against the coating device, in particular nestles partially against the outer contour thereof.

In this way, coating device and flow guide element terminate flush with one another in the second position, as a result of which the first and the second region within the processing chamber themselves are separated from one another in a comparatively tight manner in the second position.

In a preferred embodiment, a side surface of the coating device forms a control surface for the introduced process gas stream in the first end position.

The coating device itself thus functions as a type of flow guide element for the process gas stream, as a result of which, inter alia, additional materials for guide elements which are otherwise to be provided separately can be saved.

In a preferred embodiment, the side surface of the coating device in the first end position and an outer contour of the flow guide element in the first position lie in the same plane relative to the processing chamber.

In this way, the coating device in the first end position partially assumes the position of the flow guide element, and therefore the flow boundary surface for the process gas stream in the first position of the flow guide element corresponds geometrically as far as possible to the flow boundary surface for the process gas stream when the coating device is situated in the first end position. The geometric boundary conditions for the process gas stream therefore remain largely unchanged for the two said configurations, and therefore different influences on the process gas stream cannot be expected in the two cases.

In a preferred embodiment, a restoring weight is fastened to the flow guide element in such a way that the weight force thereof acts as a restoring force for restoring the flow guide element into the first position.

In this way, a restoring mechanism can be provided particularly simply and cost-effectively, which restores the flow guide element quickly into the first position, for example when the coating device moves out of the first end position and here loses contact with the flow guide element.

In addition, the restoring weight stabilizes the flow guide element when the process gas stream flows over the latter, as a result of which vibrations of the latter can be reduced and in particular can be suppressed entirely.

In a preferred embodiment, the flow guide element is designed as part of a flow guide device of the machine tool, which comprises at least one further flow guide element for the process gas stream in addition to the flow guide element.

In this way, a flow guide device comprising multiple flow guide elements is provided in the machine tool, via which the interior of the processing chamber can be adapted optimally to the process gas stream in a plurality of regions and/or sections.

The further flow guide element(s) is/are preferably designed here in the manner of the “first” flow guide element, in particular as flexible surface elements, which are preferably designed as a film element, woven element or as a sheet metal element. The use of restoring weights is likewise appropriate here too.

In a preferred embodiment, the further flow guide element is arranged parallel to the flow guide element in the first position, wherein this is not intended to be understood as a restriction of the alignment.

Thus, other alignments would likewise be possible, but the parallel arrangement is particularly space-saving.

In a preferred embodiment, the further flow guide element runs parallel to the side surface of the coating device in the first end position and terminates flush therewith in such a way that the side surface and an outer contour of the further flow guide element form a common control surface for the introduced process gas stream.

In this way, a continuously flush control surface for the process gas stream is provided in order to promote a swirl-free and turbulence-free process gas stream.

In a preferred embodiment, the flow guide device comprises a bearing device which is fastened to the processing chamber and has a drive unit, by means of which the two flow guide elements are mounted and which is set up to move the flow guide elements relative to the processing chamber in such a way that access from the first region into the second region of the inner space of the processing chamber is opened or closed.

In this way, the flow guide elements themselves can be moved in order thus to grant access to the processing region, for example in order to remove manufactured workpieces or to clean the processing region.

The flow guide elements are preferably raised or lowered here relative to the processing chamber. This is particularly suitable in the case of the embodiment as flexible surface elements, preferably with restoring weight, since it can be ensured as a result that they do not become entangled or entangled in the course of the movement movements.

The raising and lowering direction preferably runs vertically here, that is to say parallel to the gravitational field of the earth.

In a preferred embodiment, the bearing device of the flow guide device comprises a drivable shaft, to which the flow guide elements are fastened, wherein the flow guide elements can be rolled onto or off from the shaft by rotation of the shaft in such a way that the access from the first region into the second region of the inner space of the processing chamber is opened in a rolled-up state and is closed in a unrolled state.

In this way, a particularly simple movement device for the flow guide elements is provided, which allows a particularly space-saving bearing of the flow guide elements since they are “rolled up”.

The machine tool preferably comprises one or more further flow guide devices according to one of the described embodiments, wherein they preferably lie opposite one another across the building field of the machine tool, in order thus to at least partially define the processing region within the processing chamber.

According to a second aspect of the invention, a flow guide device for use in a machine tool set up for additive manufacturing is provided, in particular according to the first aspect of the invention.

The flow guide device comprises at least one (first) flow guide element and one further flow guide element, which can be fastened within a processing chamber of a machine tool for the additive layered manufacturing of workpieces and can be used as guide elements for a process gas stream flowing through the processing chamber, wherein at least the (first) flow guide element is elastically deformable between a first position, in which the flow guide element has a first outer contour geometry, and a second position, in which the flow guide element has a second outer contour geometry differing from the first.

In this way, an already existing additive machine tool can be expanded or retrofitted quickly and simply by a device guiding the process gas stream, namely the flow guide device, in order to adapt the inner space optimally to the process gas stream without major structural measures. The above-described advantages of the use of the flow guide element or of the flow guide device apply analogously here.

The embodiments of the flow guide elements, for example as flexible surface elements, have already been described above, for which reason a new reproduction is dispensed with at this point.

The flow guide device preferably comprises a restoring weight which is fastened to one of the two flow guide elements, particularly preferably the flow guide device comprises a restoring weight fastened to each flow guide element.

The two flow guide elements preferably run for the most part parallel to one another, in particular as parallel surfaces, wherein a spacing of the two surfaces in the normal direction is smaller than dimensions of the flow guide elements in the longitudinal or width direction. In particular, the spacing is at most 5%, preferably at most 1% and particularly preferably at most 0.1% of a length or width of one of the two flow guide elements.

The flow guide device preferably comprises a bearing device having a drive unit, by means of which the two flow guide elements are mounted and which is set up to move, in particular raise and/or lower, the flow guide elements relative to the processing chamber.

The bearing device of the flow guide device preferably comprises a drivable shaft, to which the flow guide elements are fastened, wherein the flow guide elements can be rolled onto or off from the shaft by rotation of the shaft.

Further aspects and their advantages and also more specific exemplary embodiments of the above-mentioned aspects and features are described below with the aid of the drawings shown in the accompanying figures.

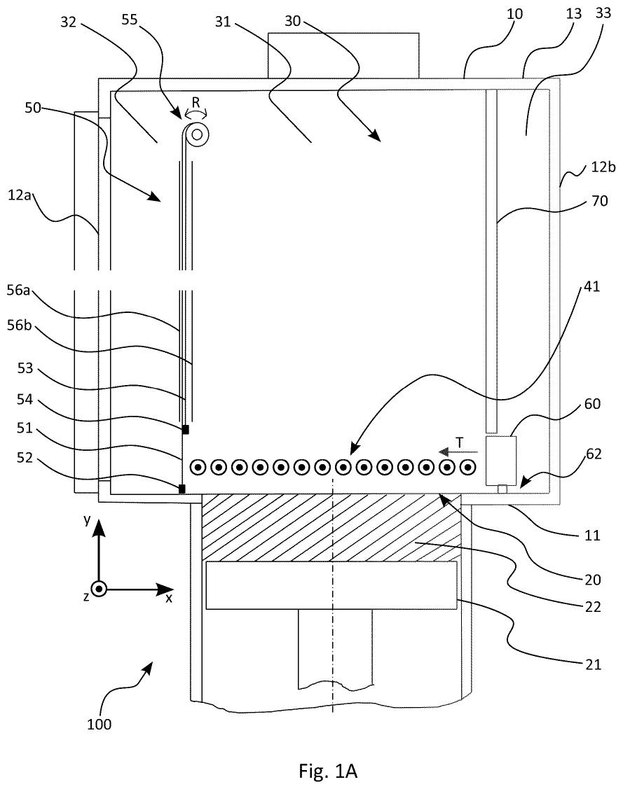

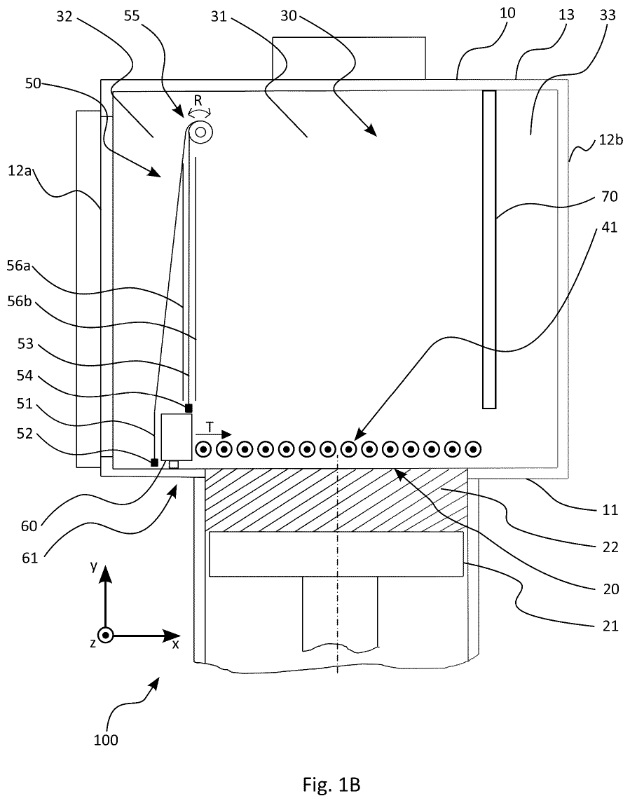

FIGS. 1A to 3 show a first exemplary embodiment of the machine tool according to the invention in different views and different positions of a coating device of the machine tool.

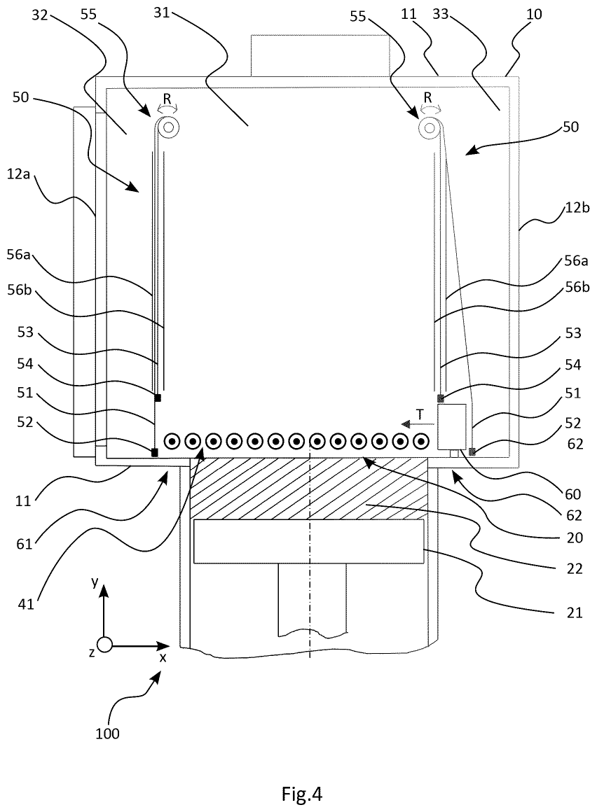

FIG. 4 shows a second exemplary embodiment of the machine tool according to the invention in a side view.

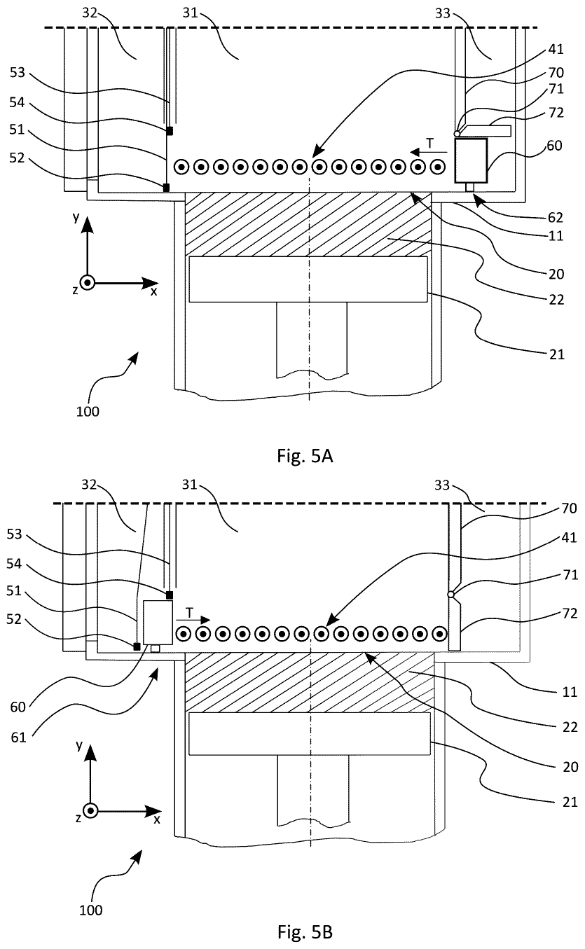

FIGS. 5A and 5B show a detail of a third exemplary embodiment of the machine tool according to the invention in a side view.

It is emphasized that the present invention is in no way limited to the exemplary embodiments described below and their exemplary features. The invention furthermore comprises modifications of the mentioned exemplary embodiments, in particular those which emerge from modifications and/or combinations of individual or multiple features of the described exemplary embodiments within the scope of protection of the independent claims.

### DETAILED DESCRIPTION OF THE FIGURES

FIGS. 1A and 1B show a first exemplary embodiment of the machine tool 100 according to the invention in a side view for two different positions of a coating device 60 of the machine tool 100 in an x-y plane of the right-handed x,y,z coordinate system introduced for direction indication.

The machine tool 100 is set up for the additive layered manufacturing of workpieces, in the course of which material 22 located on a carrier 21 is solidified at the height of a building field 20 of the machine tool 100 by irradiation successively to form layers of the workpiece to be manufactured, for example by melting or sintering of individual material particles, usually using an optical, usually laser-based irradiation device (not shown here).

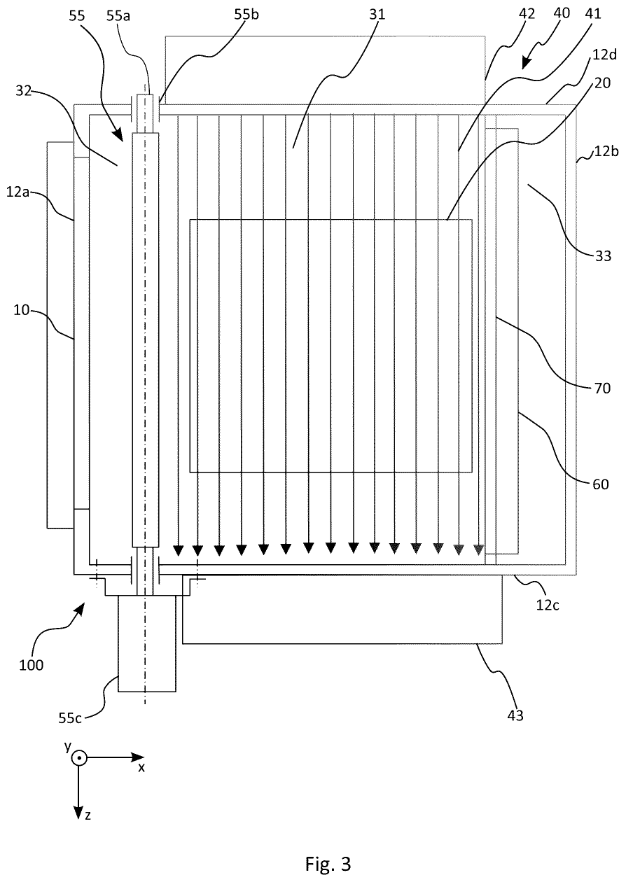

For this purpose, the machine tool 100 comprises a processing chamber 10, which surrounds an inner space 30, in which the manufacture (additive construction) of the workpieces takes place, said building field 20 with a carrier 21 movable in the y direction for the material 22, a process gas device 40 (see FIG. 3 in this regard) and a flow guide device 50.

The processing chamber 10 comprises a base element 11 terminating almost flush with the building field 20, four side elements 12a-d (two shown in FIGS. 1A and 1B) and a ceiling element 13 and together with the building field 20 encloses the inner space 30, in which the build-up takes place. In this way, the inner space 30 separated from the surroundings of the machine tool 100 is provided, in which inner space the manufacture can take place as far as possible independently of the ambient conditions.

In order to reliably remove the contaminants and pollutants (soot, exhaust gases and other by-products of the manufacture) occurring during the manufacture in the closed inner space 30 from the latter and thus to ensure constant manufacturing conditions in the inner space 30, the process gas device 40 is set up to introduce a process gas stream 41 into the processing chamber 10 during the additive manufacturing. The process gas stream 41 carries away said contaminants and pollutants and runs, for example, as a parallel flow in the z direction.

In order to guide the process gas stream 41 in a targeted and stable manner through the processing chamber 10, at least one (first) flow guide element 51 is used, which is fastened within the processing chamber 10 and is elastically deformable between a first position, in which the flow guide element 51 has a first outer contour geometry (see FIG. 1A), and a second position, in which the flow guide element 51 has a second outer contour geometry differing from the first (see FIG. 1B). The outer contour of the flow guide element 51 here forms a flow boundary surface for the process gas stream 41, which is guided along the latter from an inlet 42 up to an outlet 43 of the process gas device (see FIG. 3).

Stable is to be understood here as being as being as far as possible free of swirling, which could swirl the material 22 and thus lead to a deterioration in the manufacturing quality. Consequently, there is an increased interest in guiding the process gas stream 41 as stably as possible parallel to the building field 20 through the processing chamber 10.

The flow guide element 51 here divides the inner space 30 of the processing chamber 10 at least into a first region 31 (processing region), in which the actual manufacture takes place, and a second region 32, separated therefrom as far as possible. The process gas stream 41 here flows only through the first region 31, as a result of which the flow guide element 51 reliably shields from the process gas stream 41 interference sources (for example additional sensor systems or actuator systems) situated in the second region 32. As a result, the design of the second region 32, in particular the arrangement and choice of shape of the components of the machine tool 100 there, becomes substantially independent of the process gas stream 41.

The flow guide element 51 runs parallel to the side element 12a of the processing chamber 10 (in the y direction) and orthogonally to the building field 20 or to the base element 11 and is designed as a flexible surface element, in particular as a film element.

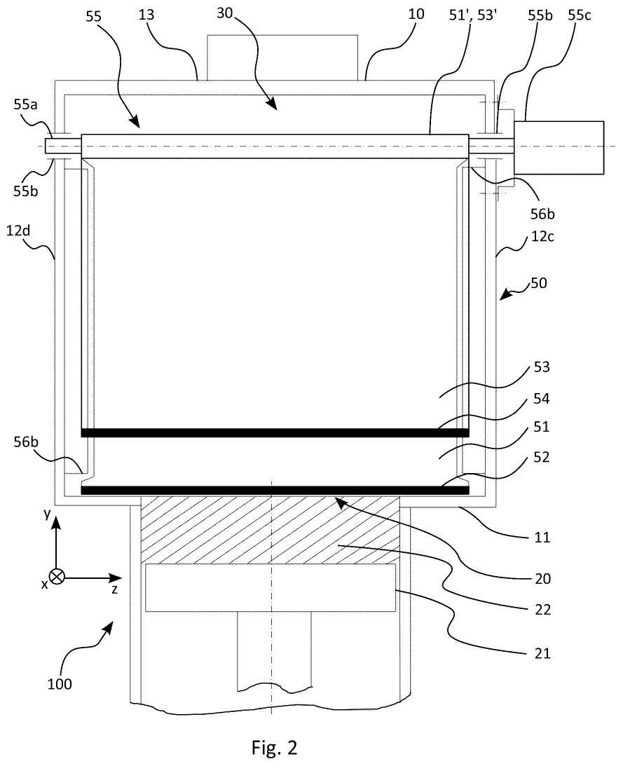

The flow guide element 51 is designed as part of the flow guide device 50, which in turn comprises a further (second) flow guide element 53, restoring weights 52, 54, a bearing device 55 for the flow guide elements 51, 53 and guide elements 56a, 56b for the lateral bearing and for guiding a movement of the flow guide elements 51, 53. The bearing device 55 and guide elements 56a, 56b will be explained in more detail later in conjunction with FIG. 2.

The restoring weights 52, 54 are fastened on the bottom side to the flow guide elements 51, 53, wherein the weight forces thereof act as restoring forces which the flow guide elements 51, 53 designed as flexible surface elements always attempt to restore into the vertical alignment shown in FIG. 1A.

The outer contours of the flow guide elements 51, 53 here serve as flow boundary surfaces for the process gas stream 41, wherein the two together define a flow boundary surface running parallel to the y-z plane in the first position shown in FIG. 1A, which flow boundary surface separates the first region 31 almost completely from the second region 32. Here, a lower edge of the first flow guide element 51 terminates almost flush with the base element 11 of the processing chamber 10.

As a result of the deformable design of the first flow guide element 51, the latter can be reversibly or elastically deformed in a simple and almost resistance-free manner between the first position shown in FIG. 1A and the second position shown in FIG. 1B.

The elastic deformation is brought about here by a movement of the coating device 60, which can be moved translationally (T) parallel to the building field 20 between a first end position 61 and a second end position 62. The coating device 60 here applies material layers to the building field 20, usually via a coating lip or brush, with which the material 22 is uniformly drawn out in a predetermined thickness. Such a movement and drawing out of a material layer must take place here in advance of each manufacturing step of an individual workpiece layer of the workpiece to be manufactured.

The coating device 60 is therefore used continuously and should therefore have to cover as short movement paths as possible with regard to short manufacturing times. Consequently, it is advantageous not to remove the coating device 60 each time from the processing chamber 10 and introduce it again into the latter, but to leave it there, which in turn makes it a potential source of disruption for the process gas stream 41 flowing through the processing chamber 10 during the manufacture.

In order to resolve this conflict, the use of the deformable first flow guide element 51 is particularly appropriate, which can be pressed away from the coating device 60 according to an overview of FIGS. 1A and 1B as soon as the latter moves into its first end position 61. There is therefore no need to move the first flow guide element 51 directly adjoining the building field 20, so that the coating device 60 can leave the region above the building space 20, as a result of which a passive adaptation of the first flow guide element 51 to the movable component coating device 60 is implemented.

If the first flow guide element 51 is designed here as a flexible surface element, the deformation by the coating device 60 requires here only a minimum of force, and therefore its movement is not disturbed unnecessarily.

In the second position shown in FIG. 1B with a second outer contour geometry of the first flow guide element 51, the latter nestles against an outer contour of the coating device 60, wherein a section lying above it is pulled away from its vertical starting position.

When the first end position 61 is reached, the right-hand side surface of the coating device 60 takes the place of the outer contour of the first flow guide element in the first position shown in FIG. 1A.

In order to provide in this case a flush, vertically running flow boundary surface for the process gas stream 41, the second flow guide element 53 is used, which in FIG. 1B terminates above the coating device 60 almost flush therewith and forms said vertical flow boundary surface with its right-hand side surface.

On the side of the second end position 62 of the coating device, a flow boundary surface is implemented by a rigid partition 70, which in an alternative embodiment according to FIG. 4 can be replaced by a further flow guide device, and which provides a third region 33 in the interior 30 of the processing chamber.

The machine tool according to the invention therefore provides the possibility for the flow guidance of the process gas stream, which inter alia enables minimum movement paths, does not require additional actuator systems and makes partial regions of the inner space particularly well adaptable to the process gas stream.

As a result, manufacturing times and maintenance effort and the associated costs can be reduced. Furthermore, a modularly constructed flow guide can be provided, which is as far as possible independent of the overall shape of the processing chamber 10 and can therefore be used for a plurality of machine tools.

FIG. 2 shows the machine tool 100 according to the first exemplary embodiment from FIG. 1A in a side view rotated by 90 degrees in the y-z plane.

As can be seen from FIG. 2, the lower ends of the flow guide elements 51, 53 are spaced apart in the vertical y direction, in order to enable a retraction of the coating device 60, in which the latter only deforms the first flow guide element 51. The latter additionally terminates flush with the base element 11 of the processing chamber 10.

Lateral end sections of the flow guide elements 51, 53 are guided in the vertical y direction by guide elements 56a, 56b attached to the side elements 12c, 12d of the processing chamber 10 (see also FIGS. 1A and 1B) and are fastened on the upper side via the bearing device 55 within the processing chamber 10. The first flow guide element 51 is here free of the lateral guide elements 56a, 56b in the position shown in FIG. 2, in order not to block a deformation by the coating device 60 (see FIG. 1B).

The bearing device 55 is designed here as a shaft 55a, which is rotatably connected to the processing chamber 10 parallel to the z direction via a bearing 55b installed in the side elements 12c, 12d. The flow guide elements 51, 53 are fastened to the shaft 55a in such a way that they can be rolled onto the shaft 55a and unrolled from the latter, with the result that the lower ends of the flow guide elements 51, 53 can be raised and lowered in the vertical y direction, in order thus to open and close an access from the first region 31 into the second region 32, for example for removing manufactured workpieces from the building field 20. For this purpose, FIG. 2 shows a quantity 51′, 53′ of the flow guide elements 51, 53 partially rolled up on the shaft 55a.

The bearing device 55 comprises a drive unit 55c, preferably electrically, via which the shaft 55a can be rotated about a rotational axis R running parallel to the z direction, in order to roll up and unroll the flow guide elements 51, 53. In the course of this, the lateral guide elements 56a, 56b serve for the targeted guidance of the flow guide elements 51, 53.

FIG. 3 shows the machine tool 100 according to the first exemplary embodiment from FIG. 1A in a plan view in the x-z plane, for better illustration of the process gas stream 41 flowing through the processing chamber 10.

For this purpose, the process gas device 40 comprises an inlet 42 arranged on the side of the side element 12d, via which the process gas stream 41 is introduced into the processing chamber 10, more precisely into the first region 31 of the inner space 30. An introduction direction here runs parallel to the plane formed by the flow guide elements 51, 53 in the position shown in FIG. 1A, which plane runs parallel to the y-z plane.

Starting from the inlet 42, the process gas stream 41 reproduced via the selected arrow illustration flows through the first region 31 up to an outlet 43 of the process gas device 40.

Flow boundary surfaces of the parallel flow of the process gas stream 41 shown in FIG. 3 are here the flow guide elements 51, 53 on the left, the side surfaces of the coating device 60 and the partition 70 and the building field 20 and the base element 11 (see also FIG. 1A in this regard).

Said elements are configured here in such a way that they form continuous and planar flow boundary surfaces, along which the process gas stream flows in a turbulence-free and preferably flow-free manner, in order thus to ensure a stable and swirl-free flow state in the first region 31 (processing region).

A swirling of the material 22 located on the building field 20 is thereby prevented, which in turn allows a constant manufacturing quality of the individual workpiece layers, since local fluctuations in a thickness of an applied material layer are thereby prevented.

FIG. 4 shows a second exemplary embodiment of the machine tool 100 according to the invention in a side view in an x-y plane.

In comparison with the first exemplary embodiment, the present machine tool 100 differs in that the separating element 70 on the right-hand side in the side view (see FIG. 1A) has been replaced by a further flow guide device 50, which is of substantially identical construction to the first, left-hand flow guide device 50.

In this way, two flow sides of the process gas stream 41 are formed using the proposed deformable flow guide element, between which the coating device 60 can be moved to and fro without the flow guide elements having to be moved in order to exclude the coating device as a source of disruption for the process gas stream. Particularly short movement paths of the coating device can thereby be implemented without risking destabilization of the process gas stream.

FIGS. 5A and 5B show a detail of a third exemplary embodiment of the machine tool 100 according to the invention in a side view in an x-y plane for two different positions of a coating device 60.

In comparison with the first exemplary embodiment, the present machine tool 100 differs in that a flap 72 mounted rotatably about a rotary joint 71 is arranged on the underside of the separating element 70 on the right-hand side in the side view (see FIG. 1A).

The upper part of the machine tool 100, which is not illustrated in the views in FIGS. 5A and 5B, is in this case identical to that of the first exemplary embodiment from FIG. 1A, and the left-hand flow guide device is also of identical design, and therefore no further explanations in this regard are made at this point.

Flap 72 is fastened to the partition via the rotary joint 71 in such a way that the partition is rotatable by a movement of the coating device 60 between a vertical starting position (see FIG. 5B), in which the partition separates the first region 31 from the third region 33 of the interior 30, and a horizontal position (see FIG. 5A).

The rotary joint 71 preferably comprises a restoring element, for example a spring element, via which the flap 72 is reliably brought into its vertical starting position (in addition to the weight force acting thereon) when the flap loses contact with the coating device 60, in order thus to again form a planar flow interface for the process gas stream 41.

In said vertical starting position, outer contours of the partition 70 and of the flap 72 preferably form a planar, in particular vertically running, flow interface for the process gas stream 41.

In said horizontal position, the coating device 60 has reached its second end position 62 and the flap 72 has been pressed away from the vertical starting position into the third region 33. The machine tool 100 is in this case preferably designed in such a way that outer contours of the partition 70 and of the coating device 60 in its second end position 62 form a planar, in particular vertically running, flow interface for the process gas stream 41, as is also the case for the configuration shown in FIG. 1A.

The rotatable flap 72 thus implements a closable access for the coating device 60 to the third region 33 of the interior 30, wherein there is always a planar and substantially continuously running flow interface. As a result, compared with the first exemplary embodiment, the guidance of the process gas stream 41 can be improved at least for the case where the coating device is situated in its first end position 61 on the left side.

Exemplary embodiments of the present invention and their advantages have been described above in detail with reference to the accompanying figures.

Finally, it is again emphasized that the present invention is in no way limited to the exemplary embodiments described above and their exemplary features. The invention furthermore comprises modifications of the mentioned exemplary embodiments, in particular those which emerge from modifications and/or combinations of individual or multiple features of the described exemplary embodiments within the scope of protection of the independent claims.

### List of Reference Signs

10 processing chamber
11 base element
12a-d side elements
13 ceiling element
20 building field
21 movable carrier
22 material
30 inner space of the processing chamber
31 first region (processing region)
32 second region
33 third region
40 process gas device
41 process gas stream
42 inlet
43 outlet
50 flow guide device
51, 51′ first flow guide element
52 first restoring weight
53, 53′ second flow guide element
54 second restoring weight
55 bearing device
55a shaft
55b bearing
55c drive
56a,b guide elements
60 coating device
61 first end position
62 second end position
70 partition
71 rotary joint
72 flap
100 machine tool

1. Machine tool for the additive layered build-up of workpieces, comprising:
a processing chamber in which the additive construction of workpieces takes place;
a processing gas device, which is set up to introduce a process gas stream into the processing chamber during the additive build-up;
characterized by
a flow guide element for the process gas stream, which is fastened within the processing chamber and which is elastically deformable between a first position, in which the flow guide element has a first outer contour geometry, and a second position, in which the flow guide element has a second outer contour geometry differing from the first.

2. Machine tool according to claim 1, characterized in that
the flow guide element is designed in such a way that the first outer contour geometry corresponds to a planar surface.

3. Machine tool according to claim 2, characterized in that
the flow guide element is arranged in the first position in such a way that the planar surface runs parallel to an introduction direction of the introduced process gas stream.

4. Machine tool according to claim 1, characterized in that
the flow guide element is designed as a flexible surface element.

5. Machine tool according to claim 4, characterized in that
the flexible surface element is a film element or a woven element.

6. Machine tool according to claim 4, characterized in that
the flexible surface element is a metallic sheet metal element, in particular a spring steel strip.

7. Machine tool according to claim 1, characterized in that
the flow guide element divides an inner space of the processing chamber at least into a first region and into a second region in the first position, wherein the first region is a processing region, in which the additive construction takes place, wherein the process gas device is set up to introduce the process gas stream into the first region.

8. Machine tool according to claim 7, characterized in that
a building field of the machine tool, on which the layered build-up takes place, is arranged completely in the first region.

9. Machine tool according to claim 7, characterized in that
the processing chamber comprises lateral housing elements, a top-side housing element and a bottom-side housing element, wherein the housing elements and the flow guide element are arranged with respect to one another in such a way that, in the first position of the flow guide element, the introduced process gas stream flows as a parallel flow along the flow guide element through the first region of the inner space of the processing chamber.

10. Machine tool according to claim 1, characterized in that
the machine tool comprises a coating device which is movable relative to the processing chamber between a first and a second end position, is set up to apply material layers for the additive build-up to a building field of the machine tool in the processing chamber, and is furthermore set up to elastically deform the flow guide element between the first position and the second position by a movement.

11. Machine tool according to claim 10, characterized in that
the flow guide element is brought into the second position when the coating device is situated in its first end position, wherein the flow guide element here bears at least partially against the coating device.

12. Machine tool according to claim 11, characterized in that
a side surface of the coating device forms a control surface for the introduced process gas stream in the first end position.

13. Machine tool according to claim 1, characterized in that
the side surface of the coating device in the first end position and an outer contour of the flow guide element in the first position lie in the same plane relative to the processing chamber.

14. Machine tool according to claim 1, characterized in that
a restoring weight is fastened to the flow guide element in such a way that the weight force thereof acts as a restoring force for restoring the flow guide element into the first position.

15. Machine tool according to claim 1, characterized in that
the flow guide element is designed as part of a flow guide device of the machine tool, which comprises at least one further flow guide element for the process gas stream in addition to the flow guide element.

16. Machine tool according to claim 15, characterized in that
the further flow guide element is arranged parallel to the flow guide element in the first position.

17. Machine tool according to claim 12, characterized in that
the further flow guide element runs parallel to the side surface of the coating device in the first end position and terminates flush therewith in such a way that the side surface and an outer contour of the further flow guide element form a common control surface for the introduced process gas stream.

18. Machine tool according to claim 7, characterized in that
the flow guide device comprises a bearing device which is fastened to the processing chamber and has a drive unit, by means of which the two flow guide elements are mounted and which is set up to move the flow guide elements relative to the processing chamber in such a way that access from the first region into the second region of the inner space of the processing chamber is opened or closed.

19. Machine tool according to claim 18, characterized in that
the bearing device of the flow guide device comprises a drivable shaft, to which the flow guide elements are fastened, wherein the flow guide elements can be rolled onto or off from the shaft by rotation of the shaft in such a way that the access from the first region into the second region of the inner space of the processing chamber is opened in a rolled-up state and is closed in a unrolled state.

20. The machine tool of claim 15, wherein the machine tool utilizes a bearing device.
